(19) United States
(12) Patent Application Publication
(10) Pub. No.: US 2023/0267647 A1
(43) Pub. Date: Aug. 24, 2023

(54) SINGLE-SHOT CAMERA CALIBRATION

(71) Applicant: Telemetry Sports LLC, Noblesville, IN (US)

(72) Inventors: Jordan Bradford Chipka, Commerce Twp., MI (US); Jeremy Herald Hochstedler, Noblesville, IN (US)

(73) Assignee: Telemetry Sports LLC, Noblesville, IN (US)

(21) Appl. No.: 18/111,201

(22) Filed: Feb. 17, 2023

Related U.S. Application Data
(60) Provisional application No. 63/311,730, filed on Feb. 18, 2022.

(51) Int. Cl. G06T 7/80; G06V 10/77; G06V 10/82

(52) U.S. Cl. CPC G06T 7/80; G06V 10/7715; G06V 10/82

(57) ABSTRACT

Aspects of the present disclosure relate to automated camera calibration. In examples, features are identified within image data of a scene that was captured by an image capture device. For instance, semantic segmentation may be used to identify the features within the image data. The identified features may be processed based on one or more geometric constraints to generate three-dimensional reference points within the scene that are associated with two-dimensional locations of the image data. Multiple candidate sets of camera parameters may be generated based on the reference points. Noisy and/or unreliably candidate sets may be omitted, and remaining candidate sets of camera parameters may be used to generate a final set of camera parameters. The final set of camera parameters may be used to derive information associated with the scene from which the image data was captured.

### CROSS-REFERENCE TO RELATED APPLICATIONS

This application claims priority to U.S. Provisional Patent Application No. 63/311,730, titled “SINGLE-SHOT AUTOMATED CAMERA CALIBRATION,” filed Feb. 18, 2022, the entirety of which is incorporated by reference herein.

### BACKGROUND OF THE DISCLOSURE

In examples, an image capture device may introduce warp or distortion into image data (e.g., an image or a video) that is captured of a three-dimensional (3D) scene as a result of characteristics of the image capture device. This distortion may make it difficult to process the image data to derive information about the 3D scene, especially in instances where the characteristics of the image capture device are not known or are not consistent between captured representations of the 3D scene.

It is with respect to these and other general considerations that embodiments have been described. Also, although relatively specific problems have been discussed, it should be understood that the embodiments should not be limited to solving the specific problems identified in the background.

### SUMMARY OF THE DISCLOSURE

Aspects of the present disclosure relate to automated camera calibration. In examples, features are identified within image data of a scene that was captured by an image capture device. For instance, semantic segmentation may be used to identify the features within the image data. The identified features may be processed based on one or more geometric constraints to generate three-dimensional reference points within the scene that are associated with two-dimensional locations of the image data. Multiple candidate sets of camera parameters may be generated based on the reference points. Noisy and/or unreliably candidate sets may be omitted, and remaining candidate sets of camera parameters may be used to generate a final set of camera parameters. The final set of camera parameters may be used to derive information associated with the scene from which the image data was captured.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for automated camera calibration.

FIG. 2 illustrates an overview of an example method for processing image data captured by an image capture device to perform automated camera calibration with which to derive information about a three-dimensional scene according to aspects described herein.

FIG. 3A illustrates an overview of an example method for extracting and mapping two-dimensional features to known three-dimensional reference points according to aspects described herein.

FIG. 3B illustrates an overview of an example method for processing user input corresponding to two-dimensional features to map the two-dimensional features to known three-dimensional reference points according to aspects described herein.

FIG. 4 illustrates an overview of an example method for generating and processing a set of candidate parameters from image data to perform automated camera calibration.

FIGS. 5A-5E illustrate example aspects of automated camera calibration according to aspects described herein.

FIG. 6 illustrates an example of a suitable operating environment in which one or more aspects of the present application may be implemented.

### DETAILED DESCRIPTION OF THE DRAWINGS

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, an image capture device is used to capture image data associated with a scene. For example, the image capture device may capture an image or one or more frames of video. The image capture device may be a fixed image capture device (e.g., a surveillance camera, traffic camera, or a pan/tilt/zoom (PTZ) camera) or a movable image capture device (e.g., a video camera, a digital single-lens reflex (DSLR) camera, a mobile computing device, a remote-controlled drone, or a satellite). An image capture device may capture any of a variety of wavelengths, for example in the visible light and/or infrared spectrums, among other examples. It will be appreciated that any of a variety of scenes may be captured, including, but not limited to, at least a part of a sports field, a traffic intersection, a parking lot, a store, or a crop, among any of a variety of other three-dimensional environments.

The captured image data may be used to perform a variety of processing, including, but not limited to, object detection or recognition and/or movement analysis (e.g., determining the position of an object, the magnitude and/or rate of change of the velocity of the object, or other movement information). For example, player performance, pedestrian walking patterns, crop growth, wildlife migration routes, intersection traffic, retail customer behaviors, and/or weather patterns may be evaluated as a result of such processing. Additionally, patterns, trends, and/or changes over time may be identified based on previous processing (e.g., in historical data), which may be used to train a machine learning model to make predictions and/or inform future analyses.

However, performing these and other analyses may be difficult as a result of warp or distortion introduced by the image capture device. For example, processing accuracy may be decreased or certain processing may be difficult or impossible to perform as a result of the distortion between the two-dimensional (2D) representation obtained by the image capture device and the three-dimensional (3D) scene itself. In some instances, additional hardware may be used to account for the distortion introduced by the image capture device (e.g., one or more light detection and ranging (LIDAR) sensors, radio beacons, reflective markers, or additional image capture devices), an image capture device may be calibrated beforehand to thus have a set of fixed or otherwise known parameters, or characteristics of the image capture device may need to be known before processing can be performed. However, these and other such mitigations may introduce additional complexity, decrease reliability (e.g., as a result of unexpected changes requiring recalibration), and may make it difficult to reliably process image data from different image capture devices or image data from the same image capture device associated with different scenes.

Accordingly, aspects of the present application relate to automated camera calibration. In an example, a set of camera parameters is automatically determined for an image capture device according to aspects of the present disclosure, which may then be used to reliably derive information from the captured image data. As used herein, a camera parameter is associated with one or more characteristics of an image capture device. Example camera parameters include, but are not limited to, intrinsic camera parameters (e.g., focal length, optical center, skew, and/or distortion of the camera) and extrinsic camera parameters (e.g., coordinates of the camera and/or one or more associated rotation angles in 3D space). As an example, a camera focal length may be determined according to aspects described herein, while one or more other camera parameters may be estimated, assumed, or otherwise fixed, thereby reducing the amount of variables for which to solve. For instance, it may be assumed that the image capture device has square pixels (e.g., such that the focal length in x and y directions are equal), that the optical center coincides with the center of the image data, that there is little to no skew, and/or that there is little to no distortion.

As noted above, the present aspects may be used to process image data associated with any of a variety of scenes. In examples, a set of rules is associated with a scene, such that the set of rules is used to process the image data to generate a set of camera parameters accordingly. For example, the set of rules may define features and associated geometric constraints, such that the features may be used to associate 2D locations within the image data to coordinates in 3D space (which may be referred to herein as “reference points”). In some examples, a rule may include processing to be performed based on the image data, such as performing text recognition to identify text associated with a feature.

As an example, a set of rules may be associated with processing image data for a scene associated with a football field. The set of rules may describe a set of feature classes to be identified within obtained image data, as well as a geometric relationship between identified features within a feature class or across different feature classes. Example feature classes include, but are not limited to, yard lines (e.g., each of which are parallel, are spaced apart according to a predetermined distance, and have an associated order), sidelines (e.g., width and spacing), hash marks, and/or end lines. Thus, example geometric relationships include spacing, sizing, and/or angles relative to one or more other features or feature classes. A rule may utilize text recognition with respect to at least a part of an identified feature to determine a yard number (e.g., 10, 20, 30, 40, etc.) associated with a given yard line feature. As another example, image recognition may be performed to recognize a logo central to the football field or at an end zone. While example reference points are provided, it will be appreciated that any of a variety of additional or alternative reference points may be used in other examples.

In another example, a set of rules may be associated with processing image data associated with a traffic intersection. For example, the rules may describe geometric relationships for a set of feature classes including, but not limited to, a cross walk pattern and/or dimensions, lane markings, and objects (e.g., fire hydrants, lamp posts, traffic lights, telephone poles, buildings, landmarks, etc.). Thus, the rules may describe an arrangement of lane markings with respect to one another or the location of a crosswalk in relation to a sidewalk, median, and/or traffic light among other examples. It will therefore be appreciated that features need not be two-dimensional or coplanar and may be three-dimensional and/or at any of a variety of locations within a given scene.

A set of rules may be hierarchical, such that a subset of rules is associated with a specific scene subcategory. For example, for a set of rules associated with football, a first subset of rules may be associated with high school football, a second subset of rules may be associated with college football, and a third subset of rules may be associated with professional football. As another example, for a set of rules associated with basketball, a first subset may be associated with high school basketball, a second subset may be associated with college basketball, and a third subset may be associated with professional basketball. In a further example, a subset of rules may be associated with varying scene dimensions or any of a variety of other subcategories or attributes. Such subsets need not be mutually exclusive, such that the same rule may be associated with multiple subcategories in some examples. Alternatively, such subsets may instead be stored as separate sets in other examples.

While example scenes and associated feature classes are described, it will be appreciated that similar techniques are applicable to any of a variety of other contexts. For example, aspects of the present disclosure may similarly be applied to indoor scenes (e.g., inside of a parking garage or retail store) or scenes spanning larger or smaller regions (e.g., land/crops, cities, or the inside of a closet or storage space). Thus, the automated camera calibration techniques described herein may be applied to any of a variety of scenes based on an associated set of rules that describes a geometric relationship of features within any of a variety of scenes. Further, in some instances, the set of rules need not describe a relationship among multiple features within a scene, and may instead define a size and/or shape of one or more features, such that the size/shape of the feature itself may be used to generate multiple 3D reference points for use according to aspects described herein. Further, a feature need not be fixed, but may instead be an object that is placed at a known or pre-defined location (e.g., within the scene or with respect to one or more features or other objects), such as a cone or other marker.

It will thus be appreciated that aspects of the present application enable automated camera calibration with a reduced amount of prior calibration or known information about the image capture device itself. Further, the image capture device need not be fixed and reference points utilized to perform the calibration process need not be coplanar. Finally, image data may be processed from any of a variety of image capture devices or from an image device with changing characteristics (e.g., as may occur as a result of a zoom lens).

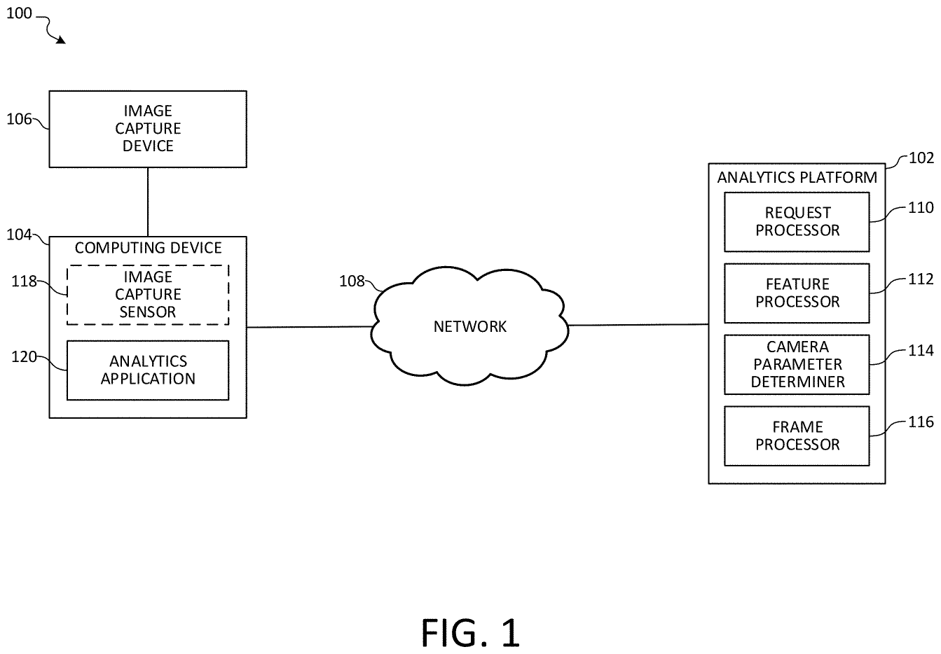

FIG. 1 illustrates an overview of an example system 100 for automated camera calibration. As illustrated, system 100 comprises analytics platform 102, computing device 104, image capture device 106, and network 108. In examples, analytics platform 102 and computing device 104 communicate via network 108. For example, network 108 may comprise a local area network, a wireless network, or the Internet, or any combination thereof, among other examples.

In examples, image capture device 106 is any of a variety of devices, including, but not limited to, a surveillance camera, a traffic camera, a PTZ camera, a video camera, a DSLR camera, a point-and-shoot camera, a drone, or a satellite. Image capture device 106 may thus generate image data with which aspects of the present application may be performed. For example, image capture device 106 may generate images and/or one or more frames of video. In other examples, image capture device 106 may utilize network 108 to communicate (e.g., with analytics platform 102 and/or computing device 104).

Computing device 104 may be any of a variety of computing devices, including, but not limited to, a mobile computing device, a tablet computing device, a laptop computing device, an augmented reality (AR) and/or virtual reality (VR) headset device, or a desktop computing device. Computing device 104 is illustrated as comprising analytics application 120 and, optionally, image capture sensor 118. Thus, computing device 104 may obtain image data from image capture sensor 118 as an alternative to or in addition to image data obtained from image capture device 106 (e.g., via a wired or wireless connection).

Analytics application 120 may process the obtained image data, for example based on camera parameters generated by analytics platform 102. In examples, analytics application 120 may provide at least a part of the obtained image data to analytics platform 102, in response to which a set of camera parameters may be received. Accordingly, analytics application 120 may perform any of a variety of analyses on the obtained image data, including, but not limited to, object recognition and/or movement analysis. In other examples, analytics application 120 receives annotated image data from analytics platform 102, which analytics application 120 may present to a user of computing device 104.

In some instances, analytics application 120 may receive user input to manually adjust aspects of the automated camera calibration (e.g., to adjust identified reference points or to associate reference points across multiple perspectives) performed by analytics platform 102 (e.g., as may be provided prior to, during, or after processing by analytics platform 102). As another example, analytics application 120 receives user input to indicate a set of 2D locations and corresponding 3D coordinates, which may thus be used to generate reference points according to aspects described herein. It will be appreciated that analytics application 120 may be any of a variety of applications, including, but not limited to, a video processing application or a web browser. For instances, analytics platform 102 may provide a website (e.g., via request processor 110) to which analytics application 120 may upload a video, such that an annotated video may be received for presentation to the user in response.

Analytics platform 102 processes image data according to aspects described herein. For example, analytics platform 102 may process image data obtained by image capture device 106 to automatically generate a set of camera parameters with which to derive information associated with a 3D scene. As illustrated, analytics platform 102 includes request processor 110, feature processor 112, camera parameter determiner 114, and frame processor 116.

Request processor 110 may receive and process requests, as may be generated by analytics application 120 of computing device 104. For example, analytics application 120 may provide image data to request processor 110 for processing. Analytics platform 102 may then process the image data (e.g., using feature processor 112, camera parameter determiner 114, and frame processor 116), such that request processor 110 may provide a processing result in response.

Example processing results include, but are not limited to, a set of determined camera parameters, identified objects, and/or associated movements, or image data that has been annotated based on processing associated with the determined camera parameters. For example, a user may upload a video from computing device 104 (e.g., as may have been captured by image capture device 106) to analytics platform 102, such that an annotated video may be received in response. In another example, the determined camera parameters may be provided to analytics application 120, which may process the image data and display derived information to a user of computing device 104 accordingly.

Feature processor 112 identifies features within image data, for example according to a set of rules associated with a scene from which the image data was obtained. For example, if the image data is associated with a football game, a baseball game, or a basketball game, the image data may be processed using a set of rules associated with football, baseball, or basketball, respectively. As described above, the set of rules may define one or more geometric relationships among identified features, such that coordinates in 3D space may be determined using the image data. Returning to the example where the image data is associated with a football game, feature processor 112 may identify yard lines, sidelines, and hash marks. As a result of geometric constraints associated with the identified features, feature processor 112 may generate a set of 3D reference points based on the image data, such as the intersection points between the yard lines and sidelines, as well as intersection points between the yard lines and lines connecting the hash marks, among other examples.

Feature processor 112 may perform semantic segmentation using a convolutional neural network to identify various classes of features (e.g., as may be described by the set of rules) within obtained image data. In examples, the neural network may have been trained based on features associated with a given type of scene. For example, the neural network may have been trained to identify features associated with football or sports more generally. As another example, the neural network may have been trained to identify objects in an urban environment, such as fire hydrants, medians, curbs, and store aisles, among other examples. In some examples, feature processor 112 encodes or otherwise stores the identified features as an intermediate image, where each identified feature class is encoded or otherwise represented in the intermediate image. For instance, each identified feature class may have an associated color or channel in the intermediate image. Returning to the football example, yard lines may be represented using a first color, hash marks may be represented using a second color, and yard line numbers may be represented using a third color.

As an example, a first identified feature class may be represented in red (e.g., #FF0000), a second identified feature class may be represented in green (e.g., #00FF00), and a third identified feature class may be represented in blue (e.g., #0000FF). Thus, features of each of the three feature classes may later be identified and processed according to the red, green, and blue channels, respectively, of the intermediate image. While example processing and encoding techniques are described herein, it will be appreciated that any of a variety of techniques may be used to identify and store features of various feature classes. For example, additional or alternative colors may be used (e.g., yellow (#FFFF00), cyan (#00FFFF), or any of a variety of other color intensities and/or channel mixtures) and need not be limited to red, green, and/or blue channels of an image.

In examples, feature processor 112 performs additional processing for one or more identified features classes. For example, feature processor may apply a noise filter to the intermediate image, perform Canny edge detection, or identify lines within the intermediate image using a Hough line transform. In examples, feature processor 112 may perform clustering to group identified features together. For example, feature processor 112 may cluster identified yard line numbers to determine a near side and a far side of yard line numbers, among other examples. Such processing performed by feature processor 112 may be referred to herein as “intermediate preprocessing,” as it may optionally be performed to improve the reliability and confidence with which subsequent reference point extraction is performed. Thus, it will be appreciated that additional, alternative, or fewer preprocessing techniques may be used in other examples.

Feature processor 112 may process an intermediate image (e.g., as may have been preprocessed as described above) to extract one or more reference points associated with identified features. The reference points may be extracted according to the set of rules, as described above. For example, feature processor 112 may use one or more geometric constraints to process identified features and generate one or more reference points associated therewith.

As an example, feature processor 112 may identify an intersection point of a yard line and a sideline, which may be extracted as a reference point. In another example, feature processor 112 may perform text recognition with respect to an identified feature, which may be used as a label associated with one or more features, such that the label may be used when extracting a reference point (e.g., a yard line number may be determined and used to determine or confirm an ordering of identified yard lines). In another example, computer vision techniques may be used to identify an object, such that a reference point may be associated with an identified object.

While examples are described in which a set of reference points are extracted, it will be appreciated that aspects of the present disclosure need not be limited to points and similar techniques may be applied to lines and/or shapes, among other examples. For example, a reference shape may be comprised of multiple reference points.

Further, it will be appreciated that a variety of other techniques may be used to extract a set of reference points from obtained image data. For instance, computer vision techniques may be used in addition to or as an alternative to the above-described deep learning-based techniques. As an example, feature identification and/or intermediate preprocessing may be omitted, such that a set of reference points may instead be directly detected from the image data (e.g., rather than identifying yard lines and/or other image features and using associated intersection points as reference points).

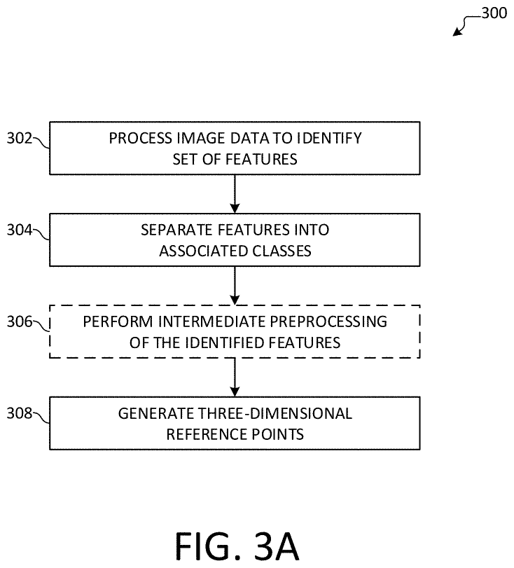

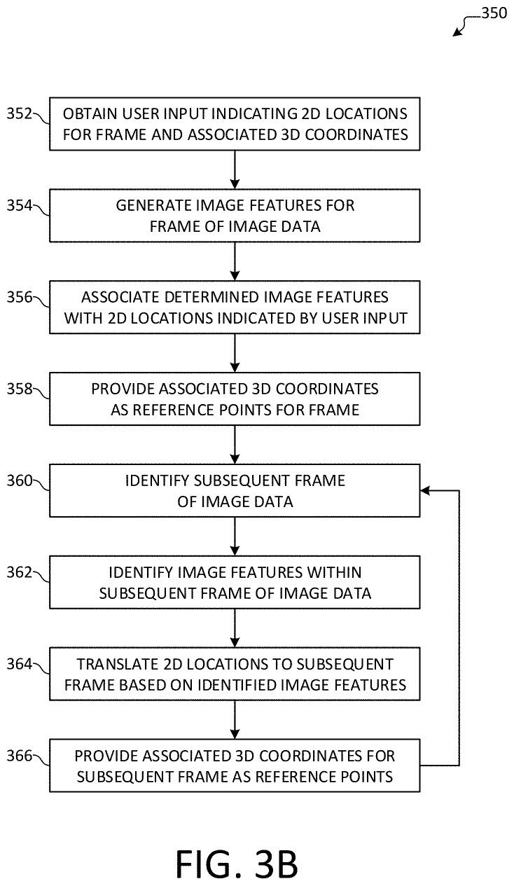

As another example, user input indicating a set of 2D locations (e.g., as may be received from analytics application 120) and corresponding 3D coordinates may be used by feature processor 112 to generate a set of reference points according to aspects described herein. For example, the user input indicates a set of 2D locations and corresponding 3D coordinates for a given frame of image data, such that the 3D coordinates are used as reference points for the given frame. In examples, one or more image features within the frame are identified in a subsequent frame (e.g., by frame processor 116, discussed below) and used to translate the 2D locations for the given frame to the subsequent frame accordingly. The corresponding 3D coordinates for the translated 2D locations may thus be used as reference points when processing the subsequent frame. Examples of such aspects are described in more detail with respect to method 350 of FIG. 3B

Camera parameter determiner 114 processes a set of reference points (e.g., as may have been extracted by feature processor 112) to generate a set of camera parameters. For example, extracted camera parameters may be used to derive information about the 3D scene captured by the obtained image data, as described above. As noted above, the set of reference points may be points in 3D space, each of which have an associated 2D location in the obtained image data.

Accordingly, camera parameter determiner 114 may utilize a solver to generate a set of candidate parameters that describe the relationship between 3D reference points and 2D locations in the obtained image data. An example solving technique is described by Oskarsson (Magnus Oskarsson. 2018. A fast minimal solver for absolute camera pose with unknown focal length and radial distortion from four planar points. arXiv: 1805.10705 (2018)), which is hereby incorporated by reference in its entirety.

In examples, camera parameter determiner 114 performs multiple solver iterations, each with a subset of reference points sampled from the set of reference points generated by feature processor 112. For example, each iteration may use at least four reference points from the set of reference points, such that a candidate set of camera parameters may be determined. It will be appreciated that four reference points are used in the instant example, but any number of points may be used in other examples, for example based on a number of points with which a solving technique is operational or accurate. In other examples, at least two or three reference points may be used.

Camera parameter determiner 114 may then filter the generated candidate camera parameter sets. For example, a transformation (e.g., a 3×3 perspective transform) may be performed using each candidate set of camera parameters to filter noisy candidates. A candidate set may be omitted or filtered out if it is determined that the candidate set does not correctly (e.g., within a predetermined error percentage) transform a 2D location of a “local” test reference point (e.g., a reference point that is within a region formed by the subset of reference points with which the candidate set was generated) to the determined location of the test reference point in 3D space.

Additional or alternative filtering may be performed, where a candidate set of camera parameters is evaluated by transforming reference points that were not used to generate the candidate set to determine whether the candidate set correctly (e.g., within another predetermined error percentage) transforms the reference points. Thus, as compared to the previous evaluation, additional test reference points are used and, further, the test reference points may not be local to the reference points from which the candidate set was generated.

The set of remaining candidates may be processed to determine a final set of camera parameters. For example, a median set of camera parameters may be generated based on each candidate set of parameters. In another example, a mean set of camera parameters is generated. In some instances, the candidate sets may be ranked (e.g., according to an error determined based on local or non-local accuracy) such that the top-ranked candidate is selected or a number of top-ranked candidates are averaged. Thus, it will be appreciated that the final set of camera parameters may be generated according to any of a variety of techniques.

In examples, analytics platform 102 processes a variety of image data, such as images and/or one or more frames of video. In examples where the image data is multiple frames of video, each frame of video may be processed as described above. For example, frame processor 116 may utilize feature processor 112 and camera parameter determiner 114 to process a given frame of video. In some examples, frame processor 116 may maintain past camera parameters, such that the processing of a subsequent frame may be based at least in part on the past camera parameters. The past camera parameters may be associated with a single previous frame, with multiple previous frames, or may be a historical and/or weighted moving average, among other examples.

Accordingly, camera parameter determiner 114 may utilize the past camera parameters when generating camera parameters for a subsequent frame of video, for example as one or more starting values or as part of filtering candidate parameters, among other examples. As another example, the past camera parameters may be used to evaluate the validity of a subsequent set of camera parameters, such that frame processor 116 may determine to omit or otherwise ignore a subsequent set of parameters if the set differs from past parameters by more than a predetermined threshold. In such an instance, frame processor 116 may instead utilize the past camera parameters for the frame if it is determined that the parameters for that frame should be omitted. As another example, temporal smoothing may be used to maintain a set of camera parameters based on past camera parameters and the determined set of camera parameters for a subsequent frame of video.

It will be appreciated that analytics platform 102 may use similar techniques to process image data of the same scene from multiple perspectives (e.g., as may be obtained by multiple image capture devices). In an example, a reference point for a first instance of image data (e.g., from a primary perspective) may be associated with a corresponding reference point in a second instance of image data (e.g., from a different or secondary perspective).

As an example, a primary perspective may capture most or all of a field, while a secondary perspective may capture an end zone in more detail (e.g., such that the secondary perspective is at a greater zoom or is closer in proximity than the primary perspective). In other examples, a secondary perspective need not provide additional detail as compared to a primary perspective and may instead provide similar or reduced detail of an overlapping region in addition to a different region of the scene. For instance, a primary perspective may capture a first half of a field and a secondary perspective may capture a second half of the field, while both perspectives include an overlapping region with the other perspective. As a further example, each perspective may capture a similar region of the field but from different locations (e.g., substantially 90 degrees or 180 degrees from each other). Any number of secondary perspectives may be used.

Corresponding reference points may be used to increase the accuracy of other reference points, which may similarly increase the accuracy with which camera parameters are determined. For instance, a primary perspective may be used to disambiguate one or more reference points that are identified for a secondary perspective, as may be the case when yard lines but not yard line numbers are visible in a secondary perspective. As a result, yard lines identified in the secondary perspective may automatically or manually be associated with corresponding yard lines in a primary perspective. In examples, a set of objects identified in a primary perspective may be used as reference points when processing a secondary perspective. As another example, multiple perspectives may be used to increase the accuracy with which objects are detected in association with the determined reference points and/or camera parameters, for example with respect to object recognition, object location determination, and/or object movement determination.

For example, tracking an object in instances where multiple objects overlap may benefit from using multiple perspectives, as a different object may be incorrectly tracked in place of the initial object when both objects overlap as captured from a single perspective. A detected object of a primary perspective may be supplemented with additional detail determined from a secondary perspective (e.g., using movement processing, computer vision, and/or any of a variety of other image processing techniques). For instance, a player name/number (e.g., as may be determined from a jersey) and/or a team logo (e.g., as may be determined from a helmet) may be better detected (e.g., at a higher degree of accuracy or as a result of improved clarity/visibility) using the secondary perspective. As another example, a machine learning model may be used to classify an object (e.g., based on multiple perspectives), for example to perform facial recognition or such that a vehicle make and/or model may be determined, among other examples. Information determined from a secondary perspective may then be associated with a corresponding object in the primary perspective.

Though reference points are described in an example where a 2D image location is associated with a reference point in 3D space (e.g., as may be determined according to a set of rules), it will be appreciated that similar techniques may be used in instances where depth data is available (e.g., as may be captured by one or more LIDAR sensors or as may be generated as a result of applying photogrammetry techniques to multiple instances of image data, among other examples).

While system 100 is illustrated as comprising one computing device 104, one image capture device 106, and one analytics platform 102, it will be appreciated that, in other examples, any number of such elements may be used. Further, it will be appreciated that functionality described above with respect to specific elements of system 100 may be distributed according to any of a variety of other paradigms in other examples. For example, computing device 104 or image capture device 106 may each locally perform at least a part of the processing described above with respect to analytics platform 102. For instance, computing device 104 may perform aspects similar to those discussed above with respect to request processor 110, feature processor 112, camera parameter determiner 114, and/or frame processor 116 in other examples.

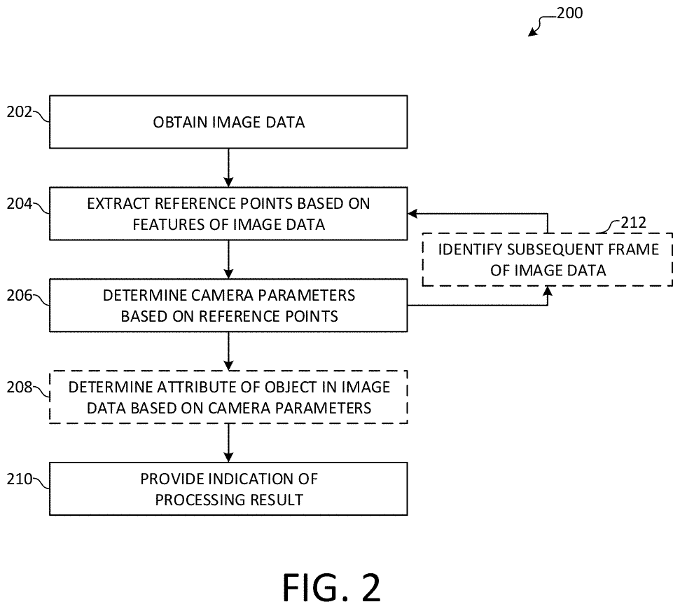

FIG. 2 illustrates an overview of an example method 200 for processing image data captured by an image capture device to perform automated camera calibration with which to derive information about a 3D scene according to aspects described herein. In examples, aspects of method 200 are performed by a feature processor and a camera parameter determiner, such as feature processor 112 and camera parameter determiner 114 discussed above with respect to FIG. 1.

Method 200 begins at operation 202, where image data is obtained. For example, the image data may be obtained from an image capture device or an image capture sensor, such as image capture device 106 or image capture sensor 118 discussed above with respect to FIG. 1. The image data may be an image or may be one or more frames of video, among other examples. The image data may be obtained from an analytics application by a request processor, such as analytics application 120 and request processor 110.

Flow progresses to operation 204, where reference points are extracted based on features of the obtained image data. For example, the reference points may be extracted according to features of identified feature classes, as may be defined by a set of rules. In examples, operation 204 comprises identifying a machine learning model with which to process the image data from a set of available machine learning models. The determination may be based on an indication of a scene type received at operation 202 in association with the obtained image data. As another example, the determination may be based on the content of the image data. For instance, it may be determined that the image data includes at least a part of a football field, hockey rink, or other sporting arena or one or more associated objects, such that an appropriate machine learning model is selected accordingly.

In another example, computer vision techniques may be used to process the image data obtained at operation 202 to extract the reference points in addition to or as an alternative to such machine learning-based techniques. For example, a reference point may be extracted directly from the obtained image data in addition to or as an alternative to extracting a reference point from an intermediate image. Additional examples of these and other aspects of operation 204 are described below with respect to method 300 of FIG. 3A.

As a further example, aspects similar to those discussed below with respect to method 350 if FIG. 3B may be used to extract reference points from the image data based on input received from a user. For example, user input corresponding to a frame of image data is processed according to operations 352-358, thereby determining 3D coordinates that correspond to 2D locations within the image data, which are thus extracted as reference points for the frame accordingly.

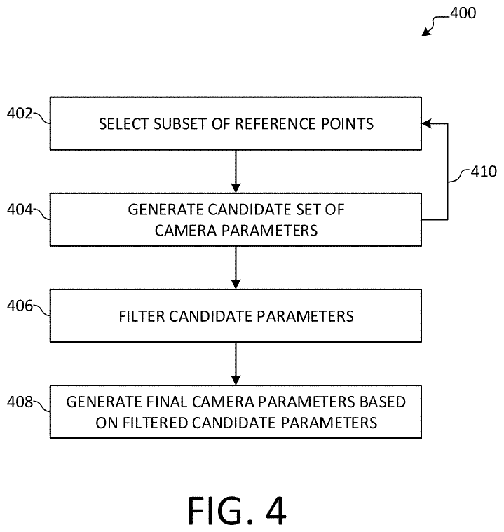

At operation 206, camera parameters are determined based on the extracted reference points. For example, a solver may be used in conjunction with a subset of reference points to generate a candidate set of camera parameters. In examples, multiple reference point subsets are processed at operation 206, thereby yielding multiple candidate sets of camera parameters. Noisy candidates and inaccurate candidates may be omitted from the candidate sets as described above (e.g., with respect to one or more predetermined thresholds). Accordingly, operation 206 may comprise determining a final set of camera parameters from multiple candidate sets, as may be accomplished by generating median or mean parameter values for each of the parameters, among other examples. Additional examples of such aspects are discussed below with respect to method 400 of FIG. 4.

In examples, flow progresses to operation 212 (e.g., when the obtained image data comprises multiple video frames), where a subsequent frame of image data is identified and processed according to operations 204-206. Example of such aspects are discussed above with respect to frame processor 116 in FIG. 1 and are therefore not necessarily re-described in detail. For example, multiple frames of video may be analyzed to derive movement information for an object, among other examples.

As another example, aspects of operations 360-366 of method 350 are performed as part of the iterative processing depicted by operations 204, 206, and 212, as may be the case when reference points are extracted based on user input. For instance, once a subsequent frame is identified at operation 212, a subsequent iteration of operation 204 comprises identifying a set of image features in the subsequent frame that each correspond to an image feature of a previous frame (e.g., as was processed by a previous iteration of operation 204). User-provided 2D locations (e.g., as may have been obtained from the user via an analytics application) may thus be transformed from the previous frame to the identified subsequent frame, such that the corresponding 3D coordinates for each of the translated 2D locations may thus be used as reference points according to aspects described herein.

Eventually, flow may progress to operation 208, where an attribute of an object in the image data may be determined based on the camera parameters. For example, as a result of the 2D-to-3D mapping enabled by the camera parameters, object detection and/or object movement analysis may be performed at operation 208. It will be appreciated that any of a variety of additional or alternative processing may be performed using the determined camera parameters, for example to determine a number of objects therein. In some examples, operation 208 comprises generating annotated image data in which one or more determined attributes are overlaid on the obtained image data. Operation 208 is illustrated using a dashed box to indicate that, in other examples, operation 208 may be omitted, such that flow progresses from operation 206 to operation 210. For instance, at least a part of operation 208 (and/or other operations of method 200) may be performed by an analytics application, such as analytics application 120 discussed above with respect to FIG. 1.

At operation 210, an indication of the processing result generated by method 200 is provided. For example, the indication may comprise a set of camera parameters (e.g., as may have been generated with respect to an image or one or more frames of video). As another example, the indication may comprise a processing result that was generated at operation 210. The indication may be provided to an analytics application, thereby enabling the analytics application to display at least a part of the processing result to a user of the computing device on which the analytics application is executing or to perform additional processing, among other examples. Method 200 terminates at operation 210.

FIG. 3A illustrates an overview of an example method 300 for extracting and mapping 2D features to known 3D reference points according to aspects described herein. In examples, aspects of method 300 are performed by a feature processor, such as feature processor 112 discussed above with respect to FIG. 1. As another example, aspects of method 300 may be performed as part of operation 204 discussed above with respect to method 200 of FIG. 2.

Method 300 begins at operation 302, where image data is processed to identify a set of features. For example, the image data may be processed using a convolutional neural network to perform semantic segmentation, thereby identifying features associated with one or more feature classes. In examples, the neural network may have been trained using training data associated with a scene from which the image data was captured, such that the neural network is usable to identify various feature classes. As another example, the machine learning model may be selected from a set of machine learning models based on a scene associated with the image data, as was discussed above with respect to operation 204 of method 200 in FIG. 2. The machine learning may be associated with a set of rules or the set of rules may specify one or more feature classes to be identified by the machine learning model, among other examples.

At operation 304, the features identified at operation 302 may be separated into associated classes. As an example, the features identified at operation 302 may be encoded as an intermediate image. In such an example, a first class of features may be encoded in the intermediate image using a first color, while a second class of features may be encoded using a second color. In some instances, the colors may each be associated with different channels of the intermediate image. As another example, the intermediate image need not be separate from the image data from which it was generated, such that the identified features may be encoded within the image data, for example as an overlay or to replace pre-existing image data associated with the identified features.

At operation 306, intermediate preprocessing is performed. For example, a noise filter may be applied to the intermediate image. As another example, Canny edge detection may be performed or lines may be identified within the intermediate image using a Hough line transform. In some examples, clustering may be performed to group identified features together. It will thus be appreciated that any of a variety of intermediate preprocessing operations may be performed as part of operation 306. Operation 306 is illustrated using a dashed box to indicate that, in some examples, it may be omitted.

Flow progresses to operation 308, where 3D reference points are generated. As described above, one or more geometric constraints may be evaluated in relation to the features that were identified as a result of operations 304-306 in order to extract associated reference points. The reference points may be extracted according to the set of rules, as described above. For example, one or more geometric constraints may be used to process an identified feature and to generate one or more reference points associated therewith. Returning to the example of processing image data associated with a football game, an intersection point of a yard line and a sideline may be identified and extracted as a reference point. As another example, text recognition may be performed at operation 308 with respect to an identified feature, the result of which may be used as a label associated with one or more features. The label may be used when extracting an associated reference point (e.g., a yard line number may be determined and used to determine or confirm an ordering of identified yard lines). In another example, computer vision techniques may be used to identify an object, such that a reference point may be associated with an identified object. Method 300 terminates at operation 308.

FIG. 3B illustrates an overview of an example method 350 for processing user input corresponding to two-dimensional features to map the two-dimensional features to known three-dimensional reference points according to aspects described herein. In examples, aspects of method 350 are performed by a feature processor and/or a frame processor, such as feature processor 112 and frame processor 116, respectively, discussed above with respect to FIG. 1. As another example, aspects of method 350 may be performed as part of operation 204 and/or operation 212 discussed above with respect to method 200 of FIG. 2.

As illustrated, method 350 begins at operation 352, where user input indicating a set of 2D locations for a given frame is obtained. In examples, the set of 2D locations is obtained from an analytics application, such as analytics application 120 discussed above with respect to FIG. 1. For example, the analytics application presents an initial frame of image data, thereby enabling the user to select one or more 2D locations accordingly (e.g., by tapping or clicking within the displayed frame of image data). It will be appreciated that the initial frame need not be the first frame of the image data. In some examples, the user is prompted to provide or the user otherwise indicates a 3D coordinate that corresponds to a selected 2D location, such each 2D location that is obtained at operation 352 further includes a corresponding 3D coordinate. While examples are described with respect to a “3D” coordinate, it will be appreciated that such a 3D coordinate may indicate a point on a plane (e.g., having an x-component and a y-component, with either no z-component or a substantially similar z-component), as may be the case when the 2D locations correspond to a position on a field or other surface. For instance, example 2D locations include, but are not limited to, cones, lines, or bases, among other examples.

At operation 354, image features are generated for an initial frame of image data. For example, the initial frame of image data corresponds to the frame for which the 2D locations were obtained. It will be appreciated that any of a variety of techniques may be used to generate image features for the frame, including, but not limited to, edge detection, object detection (e.g., via computer vision and/or machine learning techniques), and/or color change detection, among other examples.

Flow progresses to operation 356, where the generated image features are associated with the set of 2D locations. Thus, one or more image features may act as an anchor that is similarly identified in a subsequent frame of image data (e.g., at operation 362, discussed below), such that the set of 2D locations may be oriented within the subsequent frame based on the anchor accordingly. In examples, operation 356 comprises evaluating each 2D location in relation to one or more of the generated image features, for example to determine x- and y-offsets between the 2D location and the image feature. The determined offsets may thus be associated with the 2D location, such that they may be used to transform the 2D location for a subsequent frame according to aspects described herein.

Moving to operation 358, the associated 3D coordinates are provided as reference points for the initial frame. For example, the reference points are provided for subsequent processing of the frame of image data according to aspects described herein, as may be performed by operation 206 discussed above with respect to method 200 of FIG. 2.

Flow progresses to operation 360, where a subsequent frame of image data is identified. Example of such aspects are discussed above with respect to frame processor 116 in FIG. 1 and are therefore not necessarily re-described in detail. For example, multiple frames of video may be analyzed to derive movement information for an object, among other examples, such that a frame of image data after the frame that was processed above at operations 352-358 (or, in a subsequent iteration, that was processed by a previous iteration of operations 360-366) is identified accordingly.

At operation 362, image features are identified within the subsequent frame of image data. In examples, aspects of operation 362 are similar to those discussed above with respect to operation 354, such that a set of image features for the subsequent frame may be compared to image features that were identified for the previous frame to identify common image features between the two frames. In another example, the image features that were identified for the previous frame is processed to identify corresponding image features within the subsequent frame of image data accordingly. It will therefore be appreciated that any of a variety of techniques may be used to identify image features that are common to both the previous frame and the subsequent frame (e.g., one or more anchors) with which to transform the 2D locations.

Flow progresses to operation 364, where the 2D locations for the previous frame are translated for the subsequent frame based on the image features that were identified for the subsequent frame. As an example, one or more offsets corresponding to an identified image feature is used to transform or otherwise generate a corresponding 2D location for the subsequent frame, such that a 3D coordinate (e.g., corresponding to the translated 2D location) is determined for the scene depicted by the subsequent frame of image data. In examples, multiple image features are associated with a given 2D location at operation 354, such that processing of a subsequent frame may be performed with only a subset of associated image features for the given 2D location, as may be the case when not all of the initial image features are identifiable within a subsequent frame of image data.

Moving to operation 366, the 3D coordinates associated with the translated 2D locations are provided as reference points for processing the subsequent frame. For example, the reference points are provided for processing according to a subsequent iteration of operation 206 discussed above with respect to method 200 of FIG. 2.

As illustrated, method 350 loops between operations 360, 362, 364, and 366, such that a new subsequent frame of image data is identified and processed in relation to a now-previous frame of image data accordingly. Thus, image features may effectively be traced through multiple frames of image data and used to transform or otherwise generate corresponding 2D locations from which 3D coordinates within the depicted scene are determined for processing according to aspects described herein. Eventually, method 350 terminates at operation 366.

FIG. 4 illustrates an overview of an example method 400 for generating and processing a set of candidate parameters from image data to perform automated camera calibration. In examples, aspects of method 400 are performed by a camera parameter determiner, such as camera parameter determiner 114 discussed above with respect to FIG. 1. As another example, aspects of method 400 may be performed as part of operation 206 discussed above with respect to method 200 of FIG. 2.

Method 400 begins at operation 402, where a subset of reference points is selected. In examples, the subset of reference points are randomly selected from a set of reference points (e.g., as may have been generated as a result of performing operation 204 of method 200 or as a result of performing method 300 discussed above with respect to FIGS. 2 and 3, respectively). As another example, the subset of reference points are selected based on a region of image data with which they are associated (e.g., reference points may be selected from the center of the image data or from an area of interest). It will thus be appreciated that any of a variety of techniques may be used to sample reference points from a set of generated reference points.

At operation 404, a candidate set of camera parameters is generated. For example, the candidate set of camera parameters may be generated by utilizing a solver to estimate the candidate set of camera parameters based on the association between the 3D reference points and a 2D location within the image data. Arrow 410 is illustrated from operation 404 to operation 402 to illustrate that multiple iterations of operations 402 and 404 may be performed, thereby generating multiple candidate sets, where each candidate set is associated with a different (but not necessarily unique or mutually exclusive) subset of reference points.

Eventually, flow progresses to operation 406, where the candidate sets of camera parameters are filtered. For example, the candidate sets may be filtered based on performing a perspective transform of a test reference point associated with the reference points with which a candidate set was generated. As described above, the test reference point may be a local reference point. If the test reference point is transformed with an error outside of a predetermined error threshold, the candidate set of camera parameters may be omitted. As another example, the test reference point may be a reference point different from the reference points with which the candidate set was generated. For example, substantially all or most of the other reference points may be transformed to generate an error associated with a candidate set of camera parameters, such that a candidate set exhibiting an error above a predetermined threshold may be omitted. Thus, it will be appreciated that any of a variety of techniques may be used to filter the candidate sets of camera parameters at operation 406.

Moving to operation 408, a final set of camera parameters is generated based on the remaining/filtered candidate sets of camera parameters. For example, the final set of camera parameters may be the median set of camera parameters generated from each candidate set of parameters. In another example, the final set of camera parameters may be based on the mean set of filtered candidate parameters. In some instances, the candidate sets may be ranked (e.g., according to an error determined at operation 406) such that the top-ranked candidate is selected or a number of top-ranked candidates are averaged at operation 408. Thus, it will be appreciated that the final set of camera parameters may be generated according to any of a variety of techniques. Method 400 terminates at operation 408.

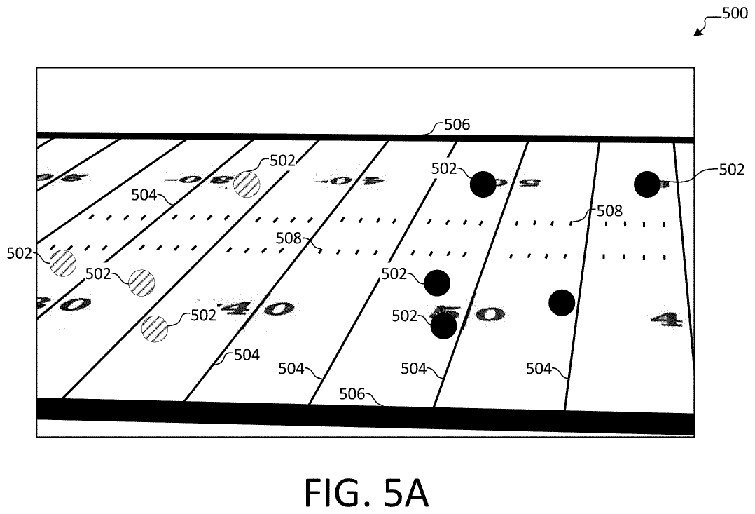

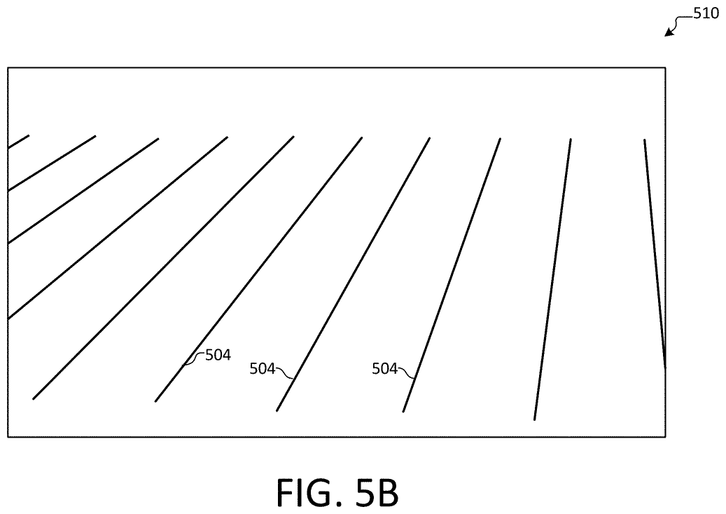

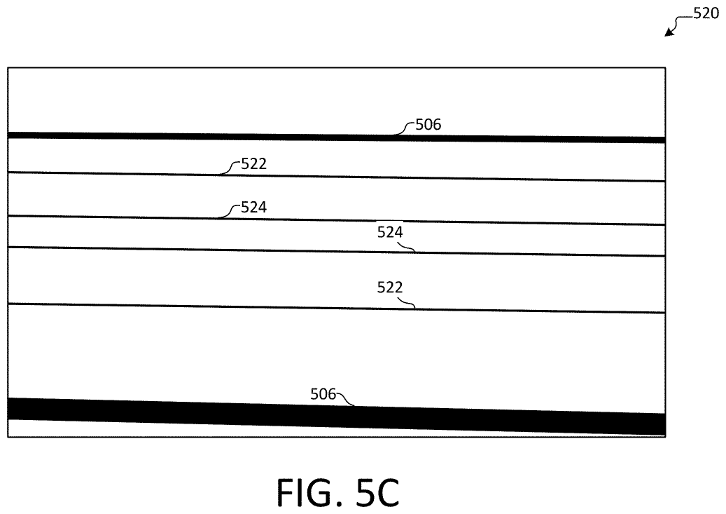

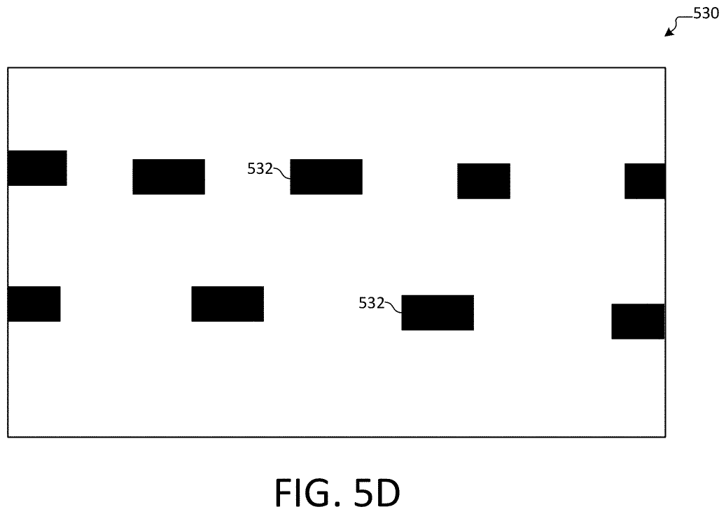

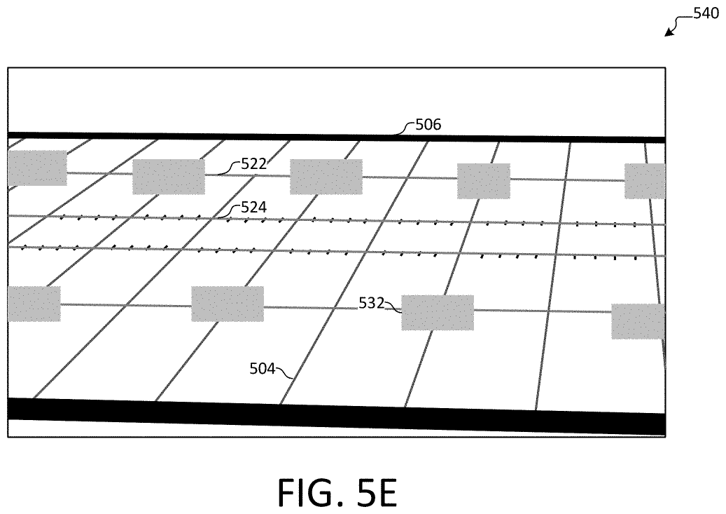

FIGS. 5A-5E illustrate example aspects of automated camera calibration according to aspects described herein. FIG. 5A illustrates an overview of example image data 500 that may be processed according to aspects described herein. As illustrated, FIG. 5A comprises image data 500 associated with a football game, including players 502, yard lines 504, sidelines 506, and hash marks 508.

Image data 500 may be processed according to aspects described herein (e.g., as discussed above with respect to feature processor 112 of FIG. 1, operation 204 of FIG. 2, and method 300 of FIG. 3) to identify features therein. For example, FIG. 5B illustrates an example intermediate image 510 associated with identifying a yard line feature class, where yard lines 504 have been identified and encoded as part of the intermediate image. Similarly, FIG. 5C illustrates intermediate image 520, where sidelines 506 have been identified and encoded in the intermediate image. Similarly, lines 524 have been encoded, which are parallel to and intersect with hash marks 508. Similarly, lines 522 are illustrated, which are parallel to and intersect with the yard line numbers depicted in FIG. 5A.

FIG. 5D is provided as an example intermediate image 530 in which regions 532 associated with the yard numbers have been identified. As described above, the content of regions 532 may be processed using text recognition techniques to determine the text associated therewith (e.g., 10, 20, 30, 40, etc.). FIG. 5E is provided as an example intermediate image 540 in which the identified feature classes have been encoded (e.g., as may be generated as a result of performing operations 302 and 304 discussed above with respect to method 300 of FIG. 3). As illustrated, each feature class is illustrated using a different color, each of which may be associated with a different color channel of the intermediate image. The intermediate image may be processed according to aspects described herein, for example by performing aspects of operations 306 and 308 discussed above with respect to method 300 of FIG. 3A.

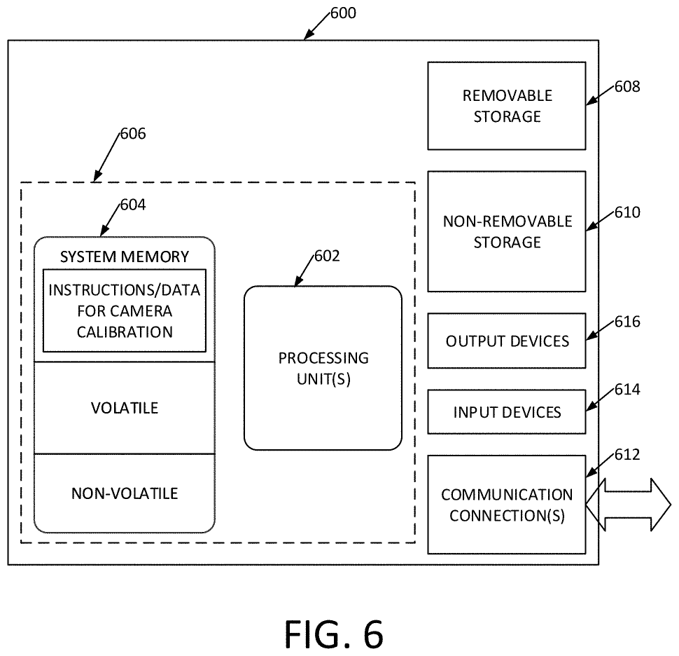

FIG. 6 illustrates an example of a suitable operating environment 600 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 600 typically may include at least one processing unit 602 and memory 604. Depending on the exact configuration and type of computing device, memory 604 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 6 by dashed line 606. Further, environment 600 may also include storage devices (removable, 608, and/or non-removable, 610) including, but not limited to, magnetic or optical disks or tape. Similarly, environment 600 may also have input device(s) 614 such as a keyboard, mouse, pen, voice input, etc. and/or output device(s) 616 such as a display, speakers, printer, etc. Also included in the environment may be one or more communication connections, 612, such as LAN, WAN, point to point, etc.

Operating environment 600 may include at least some form of computer readable media. The computer readable media may be any available media that can be accessed by processing unit 602 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 600 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 604. While executing on the processing unit 602, program modules (e.g., applications, Input/Output (I/O) management, and other utilities) may perform processes including, but not limited to, one or more of the stages of the operational methods described herein such as the methods discussed with respect to FIG. 1, 2, 3, or 4, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 600 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

As will be understood from the foregoing disclosure, one aspect of the technology relates to a system comprising: at least one processor; and memory storing instructions that, when executed by the at least one processor, causes the system to perform a set of operations. The set of operations comprises: obtaining image data captured by an image capture device of a three-dimensional (3D) scene; processing the image data to identify features within the image data; extracting a set of reference points based on the identified features; generating, based on the set of reference points, a plurality of candidate sets of camera parameters; filtering the candidate sets of camera parameters to generate filtered candidate sets; and processing the filtered candidate sets to generate a final set of camera parameters for the image capture device. In an example, processing the image data to identify features comprises: identifying the features using a machine learning model, wherein the features are associated with a feature class; encoding the identified features in an intermediate image; and processing the intermediate image using a set of geometric constraints associated with the feature class to extract the set of reference points. In another example: the features comprise a first set of features associated with a first feature class; and the set of operations further comprises: identifying a second set of features using the machine learning model, wherein the second set of features are associated with a second feature class. In a further example, the second set of features is encoded in the intermediate image using a different color or channel than a color or channel used to encode the first set of features. In yet another example, the features are identified using a convolutional neural network trained to perform semantic segmentation. In a further still example, each candidate set of the plurality of candidate sets is generated based on a subset of reference points sampled from the set of reference points. In another example, filtering the candidate sets comprises at least one of: evaluating a candidate set of camera parameters of the candidate sets using a test reference point that is local to a subset of reference points used to generate the candidate set; or evaluating the candidate set of camera parameters using a plurality of test reference points that are different from the subset of reference points used to generate the candidate set of camera parameters. In a further example, the set of operations further comprises at least one of: identifying, based on the final set of camera parameters, an object of the 3D scene; generating, based on the final set of camera parameters, movement information for the object; and providing an indication of the final set of camera parameters to a computing device.

In another aspect, the technology relates to a method for automated calibration of an image capture device. The method comprises: obtaining image data captured by an image capture device of a three-dimensional (3D) scene; processing the image data using a machine learning model to identify features associated within the image data, wherein the features are associated with one or more feature classes defined by a set of rules; extracting a set of reference points based on one or more geometric constraints associated with the identified features, wherein the one or more geometric constraints are defined by the set of rules; and generating, based on the set of reference points, a set of camera parameters for the image capture device. In an example, generating the set of camera parameters for the image capture device comprises: generating, based on a subset of reference points sampled from the set of reference points, a plurality of candidate sets of camera parameters; filtering the candidate sets of camera parameters to generate filtered candidate sets by at least one of: evaluating a candidate set of camera parameters of the candidate sets using a test reference point that is local to a subset of reference points used to generate the candidate set; or evaluating the candidate set of camera parameters using a plurality of test reference points that are different from the subset of reference points used to generate the candidate set of camera parameters.; and processing the filtered candidate sets to generate the set of camera parameters for the image capture device. In another example, the set of rules and the machine learning model are each associated with a scene type. In a further example, the scene type is a football game; the machine learning model is trained to identify one or more of: a set of yard line features; a set of sideline features; and a set of hash mark features; and the one or more geometric constraints define a relationship between one or more of: the set of yard line features; the set of sideline features; and the set of hash mark features.

In a further aspect, the technology relates to a method for automated calibration of an image capture device. The method comprises: obtaining image data captured by an image capture device of a three-dimensional (3D) scene; processing the image data to identify features within the image data; extracting a set of reference points based on the identified features; generating, based on the set of reference points, a plurality of candidate sets of camera parameters; filtering the candidate sets of camera parameters to generate filtered candidate sets; and processing the filtered candidate sets to generate a final set of camera parameters for the image capture device. In an example, processing the image data to identify features comprises: identifying the features using a machine learning model, wherein the features are associated with a feature class; encoding the identified features in an intermediate image; and processing the intermediate image using a set of geometric constraints associated with the feature class to extract the set of reference points. In another example, the features comprise a first set of features associated with a first feature class; and the method comprises: identifying a second set of features using the machine learning model, wherein the second set of features are associated with a second feature class. In a further example, the second set of features is encoded in the intermediate image using a different color or channel than a color or channel used to encode the first set of features. In yet another example, the features are identified using a convolutional neural network trained to perform semantic segmentation. In a further still example, each candidate set of the plurality of candidate sets is generated based on a subset of reference points sampled from the set of reference points. In another example, filtering the candidate sets comprises at least one of: evaluating a candidate set of camera parameters of the candidate sets using a test reference point that is local to a subset of reference points used to generate the candidate set; or evaluating the candidate set of camera parameters using a plurality of test reference points that are different from the subset of reference points used to generate the candidate set of camera parameters. In a further example, the method further comprises at least one of: identifying, based on the final set of camera parameters, an object of the 3D scene; generating, based on the final set of camera parameters, movement information for the object; and providing an indication of the final set of camera parameters to a computing device.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
obtaining image data captured by an image capture device of a three-dimensional (3D) scene;
processing the image data to identify features within the image data;
extracting a set of reference points based on the identified features;
generating, based on the set of reference points, a plurality of candidate sets of camera parameters;
filtering the candidate sets of camera parameters to generate filtered candidate sets; and
processing the filtered candidate sets to generate a final set of camera parameters for the image capture device.

2. The system of claim 1, wherein processing the image data to identify features comprises:
identifying the features using a machine learning model, wherein the features are associated with a feature class;
encoding the identified features in an intermediate image; and
processing the intermediate image using a set of geometric constraints associated with the feature class to extract the set of reference points.

3. The system of claim 2, wherein:
the features comprise a first set of features associated with a first feature class; and
the set of operations further comprises:
identifying a second set of features using the machine learning model, wherein the second set of features are associated with a second feature class.

4. The system of claim 3, wherein the second set of features is encoded in the intermediate image using a different color or channel than a color or channel used to encode the first set of features.

5. The system of claim 1, wherein the features are identified using a convolutional neural network trained to perform semantic segmentation.

6. The system of claim 1, wherein each candidate set of the plurality of candidate sets is generated based on a subset of reference points sampled from the set of reference points.

7. The system of claim 1, wherein filtering the candidate sets comprises at least one of:
evaluating a candidate set of camera parameters of the candidate sets using a test reference point that is local to a subset of reference points used to generate the candidate set; or
evaluating the candidate set of camera parameters using a plurality of test reference points that are different from the subset of reference points used to generate the candidate set of camera parameters.

8. The system of claim 1, wherein the set of operations further comprises at least one of:
identifying, based on the final set of camera parameters, an object of the 3D scene;
generating, based on the final set of camera parameters, movement information for the object; and
providing an indication of the final set of camera parameters to a computing device.

9. A method for automated calibration of an image capture device, comprising:
obtaining image data captured by an image capture device of a three-dimensional (3D) scene;
processing the image data using a machine learning model to identify features associated within the image data, wherein the features are associated with one or more feature classes defined by a set of rules;
extracting a set of reference points based on one or more geometric constraints associated with the identified features, wherein the one or more geometric constraints are defined by the set of rules; and
generating, based on the set of reference points, a set of camera parameters for the image capture device.

10. The method of claim 9, wherein generating the set of camera parameters for the image capture device comprises:
generating, based on a subset of reference points sampled from the set of reference points, a plurality of candidate sets of camera parameters;
filtering the candidate sets of camera parameters to generate filtered candidate sets by at least one of:
evaluating a candidate set of camera parameters of the candidate sets using a test reference point that is local to a subset of reference points used to generate the candidate set; or
evaluating the candidate set of camera parameters using a plurality of test reference points that are different from the subset of reference points used to generate the candidate set of camera parameters.; and
processing the filtered candidate sets to generate the set of camera parameters for the image capture device.

11. The method of claim 9, wherein the set of rules and the machine learning model are each associated with a scene type.

12. The method of claim 11, wherein:
the scene type is a football game;
the machine learning model is trained to identify one or more of:
a set of yard line features;
a set of sideline features; and
a set of hash mark features; and
the one or more geometric constraints define a relationship between one or more of:
the set of yard line features;
the set of sideline features; and
the set of hash mark features.

13. A method for automated calibration of an image capture device, comprising:
obtaining image data captured by an image capture device of a three-dimensional (3D) scene;
processing the image data to identify features within the image data;
extracting a set of reference points based on the identified features;
generating, based on the set of reference points, a plurality of candidate sets of camera parameters;
filtering the candidate sets of camera parameters to generate filtered candidate sets; and
processing the filtered candidate sets to generate a final set of camera parameters for the image capture device.

14. The method of claim 13, wherein processing the image data to identify features comprises:
identifying the features using a machine learning model, wherein the features are associated with a feature class;
encoding the identified features in an intermediate image; and
processing the intermediate image using a set of geometric constraints associated with the feature class to extract the set of reference points.

15. The method of claim 14, wherein:
the features comprise a first set of features associated with a first feature class; and
the method comprises:
identifying a second set of features using the machine learning model, wherein the second set of features are associated with a second feature class.

16. The method of claim 15, wherein the second set of features is encoded in the intermediate image using a different color or channel than a color or channel used to encode the first set of features.

17. The method of claim 13, wherein the features are identified using a convolutional neural network trained to perform semantic segmentation.

18. The method of claim 13, wherein each candidate set of the plurality of candidate sets is generated based on a subset of reference points sampled from the set of reference points.

19. The method of claim 13, wherein filtering the candidate sets comprises at least one of:
evaluating a candidate set of camera parameters of the candidate sets using a test reference point that is local to a subset of reference points used to generate the candidate set; or
evaluating the candidate set of camera parameters using a plurality of test reference points that are different from the subset of reference points used to generate the candidate set of camera parameters.

20. The method of claim 13, wherein the method further comprises at least one of:
identifying, based on the final set of camera parameters, an object of the 3D scene;
generating, based on the final set of camera parameters, movement information for the object; and
providing an indication of the final set of camera parameters to a computing device.
